(19) United States
(12) Patent Application Publication
(10) Pub. No.: US 2003/0230011 A1
(43) Pub. Date: Dec. 18, 2003

(54) Card with rotating pop-up device

(76) Inventor: Mordeckai Mouyal, Tel Aviv (IL)

Correspondence Address: B-Moss USA, Inc., c/o Dimitri Pressman, 4th Floor, 379 Fifth Avenue, New York, NY, 10016, US

(21) Appl. No.: 10/167,519

(22) Filed: Jun. 12, 2002

(51) Int. Cl. G09F 1/00

(52) U.S. Cl. 40/124.08

(57) ABSTRACT

The card with rotating pop-up device is comprised of two elements, a Base and a Rotation Device, which Base and Rotation Device are folded and attached in such a way that, when the Base is folded along a crease, the Rotation Device lies flat, and when the Base is unfolded along said crease the Rotation Device is activated, thereby rotating an image carrier. Said card with rotating pop-up device is distinct from, and an improvement upon, other pop-up devices and other promotional materials in a number of regards: the rotating pop-up device is a particularly eye-catching form of pop-up device; the card employs a novel device in which z-shaped creases incorporated into the Rotation Device fold and unfold, propelling the rotation of the image carrier; the Rotation Device (including the image carrier) is constructed from only one sheet of cardstock or other planar material, and as such is both time and cost effective to assemble and distribute; the entire card is constructed from either one or two sheets of cardstock or other planar material, depending on its embodiment, and as such is both time and cost effective to assemble and distribute; and the pop-up mechanism is self-propelling, such that merely opening the card causes the image carrier to rotate up to 180 degrees.

### BACKGROUND OF THE INVENTION

1. Field of the Invention

The subject invention relates to the field of pop-up cards and, more particularly, to a pop-up card of the type in which an image carrier rotates when activated.

The subject invention also relates to the field of advertising and promotional techniques and, more particularly, to an advertising and/or promotional piece that includes a pop-up feature.

2. Description of the Related Art

No matter the location, the consuming public is inundated with promotional material from every type of commercial enterprise, in the form of business cards, T-shirts, hats and many other objects. In particular, the consuming public is inundated with paper advertisements in the form of newspaper inserts, catalogs, flyers, postcards, coupon books and the like. Due to these factors, advertisers are continually searching for new and more effective promotional materials with which they can gain the attention of consumers. Prior attempts to gain the attention of consumers, both in the form of paper advertisements and more generally in the form of promotional materials, have included colorful artwork, controversial slogans, eye-catching shapes, contests, coupons and novel means with which to deliver the above to the consumer. Though these methods of gaining the attention of consumers have been and continue to be successful to a certain extent, there exists a constant need on the part of companies and individuals to deliver their advertising and promotional materials in novel, attention-getting ways.

Additionally, advertisements and promotional materials must reach numerous consumers in a cost-efficient manner. Thus, the most favorable promotional materials should be simply and quickly mass manufactured and should employ inexpensive materials.

Addressing the above problems, inventors have created the field of pop-up devices, and the more particular field of pop-up cards. [For example, see U.S. Pat. Nos. 4,103,444 (Flap pop-up for advertising leaflets), 5,450,680 (Pop-up card and method of making same), 6,036,806 (Pop-up advertising device and method), 6,192,608 (Pop-up advertising piece)]. Pop-up cards peak consumer interest through the incorporation of dynamic parts. Furthermore, the possibility of displaying objects elevated or erect from the flat plane of the card enables the sender to better convey the form and shape of various objects for the benefit of the receiver. Pop-up cards are versatile, as they can be distributed in many different forms and through numerous distribution channels, including as inserts in newspapers and magazines, as mailers, as a “give-away” packaged with related products or in person by salesmen at trade shows and meetings. Moreover, pop-up cards can be made from paperboard and delivered as flat cards, thereby reducing cost of manufacture and risk of damage to said cards during delivery. However, even within the particular field of pop-ups, advertisers are always looking for innovative devices with which to deliver their messages, particularly in eye-catching ways, as the modem consumer becomes dismissive and disinterested with the familiar, and particularly with that which is static.

### BRIEF SUMMARY OF THE INVENTION

It is a general object of the present invention to provide an improved pop-up card; it is a more particular object of the present invention to provide a pop-up card with a novel rotating pop-up device.

Addressing the evolving needs of advertisers and other purveyors of information, the card with rotating pop-up device attracts and holds the attention of recipients through its novel, rotating pop-up mechanism, which mechanism employs a novel device in which z-shaped creases incorporated into a rotation device fold and unfold, propelling the rotation of an image carrier.

Moreover, addressing the limitations of other pop-up mailers, the card with rotating pop-up device is self-propelling, such that merely opening the card causes the image carrier to rotate up to 180 degrees. Furthermore, the card is made from either one or two sheets of paperboard or other planar material, depending on the embodiment, thereby making it particularly cost-effective to assemble and distribute.

### BRIEF DESCRIPTION OF THE SEVERAL VIEWS OF THE DRAWING

FIG. 1: A first implementation form of the Card with Rotating Pop-up Device with square or round image carrier. Open perspective view before assembly.

FIG. 2: Internal view of the Card with Rotating Pop-up Device before assembly.

FIG. 3: View of the partially folded card with rotating pop up device.

FIG. 4: View of the opened Card with Rotating Pop-up Device before the 1^{st} panel is glued and displaying side A of the image carrier.

FIG. 5: View of the Card with Rotating Pop-up Device before the 1^{st} panel is attached, and in its closing position, with arms of Rotation Device folding into their Z-formation and the image carrier being rotated.

FIG. 6: View of the closed of Card with Rotating Pop-up Device before the 1^{st} panel is attached and with the arms of the Rotation Device folded in their Z-Formation thereby having rotated the image carrier 180 degrees and displaying side B of the image carrier.

FIG. 7: View of the 1^{st} panel of the Card with Rotating Pop-up Device being sealed, thereby completing the assembly of the Card.

FIG. 8: A second implementation form of the Card with Rotating Pop-up Device with round image carrier. Open perspective view before assembly.

FIG. 9: Overview of the card with Card with Rotating Pop-up Device after insertion of the Rotation Device, but before complete assembly.

FIG. 10: View of the assembly of the Card with Rotating Pop-up Device after insertion of the Rotation Device.

FIG. 11: View of the assembled Card with Rotating Pop-up Device in its closed position, displaying side A of the image carrier.

FIG. 12: View of the assembled Card with Rotating Pop-up Device in a partially opened position, in the midst of the rotation of the image carrier.

FIG. 13: View of the assembled Card with Rotating Pop-up Device in its opened position, (180 degree rotation of the image carrier from the closed position), displaying side B of the image carrier.

### DETAILED DESCRIPTION OF THE INVENTION

The present invention and its objects and advantages can be illustrated by describing the structural and functional elements, assembly and characteristics of its preferred embodiments as illustrated in the Drawings.

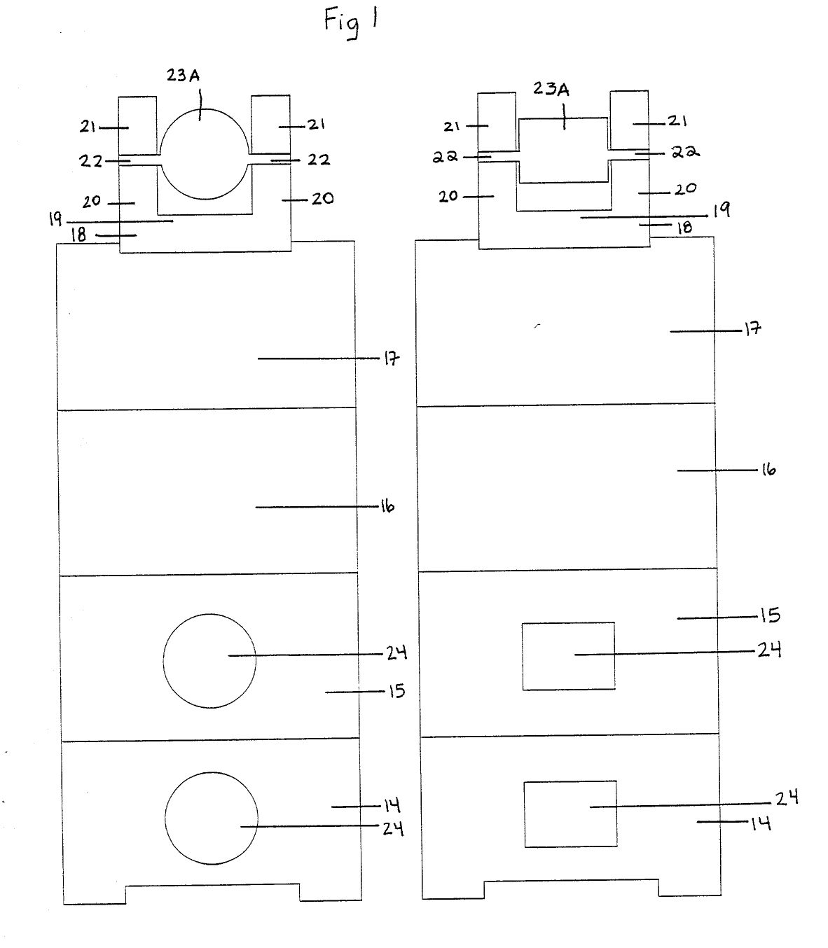

FIGS. 1 though 7 represent a first implementation form of the Card with Rotating Pop-up Device.

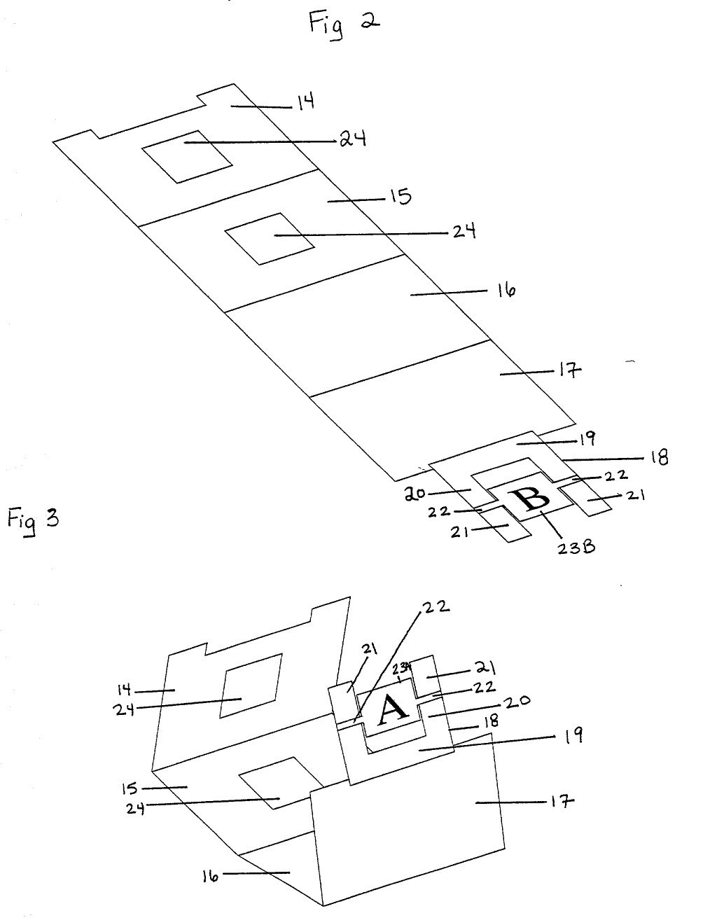

Referring to FIGS. 1 and 2, the first implementation of the Card with Rotating Pop-up Device consists of two main elements, the Base 14, 15, 16 and 17 and the Rotation Device 18. The Base 14, 15, 16 and 17 and the Rotation Device 18 are constructed from a single sheet of foldable cardstock or other planar material divided into five panels 14, 15, 16, 17 and 18 by parallel creases. The Base 14, 15, 16 and 17 is comprised of four panels 14, 15, 16 and 17, of which the first panel 14 and second panel 15 each contain openings 24 of the same size as the rotating image carrier 23.

The Rotation Device is comprised of one panel 18, which in turn is comprised of a U-Shaped piece 19, 20 and 21 (which in turn is comprised of a rectangular piece 19 and two parallel arms protruding from the rectangular piece 20, each with an arm end 21), a double-sided rotating image carrier 23 and two hinges 22 connecting the arms of the U-shaped piece 19, 20 and 21 to the image carrier 23. (The image carrier can be circular, rectangular, square or irregularly shaped.)

Referring to FIG. 3, the Card with Rotating Pop-up Device is assembled when the 4^{th} panel 17 is folded over the 3^{rd} panel 16 and fastened with the use of an adhesive and the 5^{th} panel 18 is folded over the 2^{nd} 15 panel and the arms of the Rotation Device 18 are fastened to the 2^{nd} panel 15. The 1st panel 14 is then folded over the 2^{nd} panel 15 and the 5^{th} panel 18 with the 1^{st} panel 14 being fastened to the 2^{nd} panel 15 on its top and bottom edges. Through the folding and adhesion of the various pieces, a foldable card is formed, whereby the opening and closing of the card activates the rotating of the image carrier.

FIGS. 4, 5, 6 refer to the Card with Rotating Pop-up Device before the 1^{st} panel 14 has been attached to the 2^{nd} panel 15, thereby displaying the method through which the image carrier 23 is rotated.

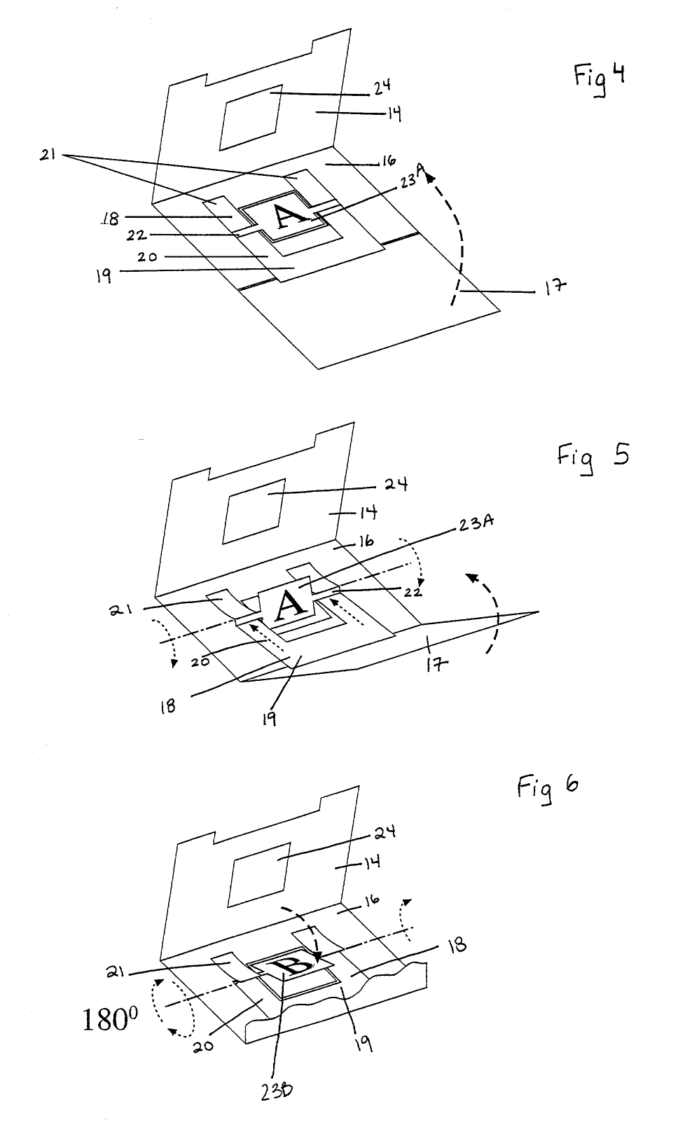

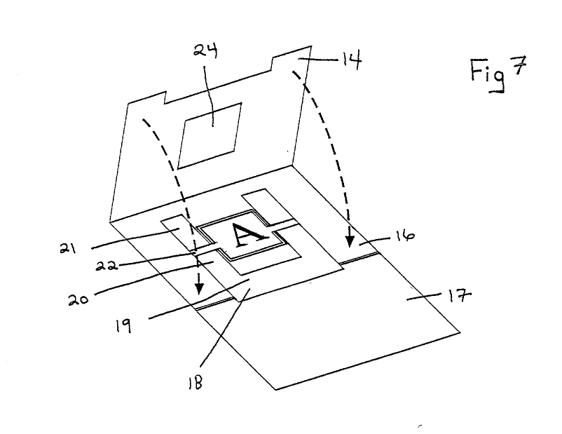

In FIG. 4 the Base 14, 15, 16 and 17 is completely opened, and side A of the image carrier 23 is displayed. In FIG. 5 the Base 14, 15, 16 and 17 is partially closed, thereby pushing the base 19 of the Rotation Device 18 and causing the arms 20 of the Rotation Device 18 to fold into a partial Z-shape. This in turn causes the image carrier 23 to partially rotate. In FIG. 6 the Base 14, 15, 16 and 17 is completely closed and the arms 20 of the Rotation Device 18 are in a complete Z-shaped fold, thereby displaying side B of the image carrier 23. FIG. 7 illustrates the sealing of the 1^{st} panel 14 to the 2^{nd} panel 15, on its top and bottom edges.

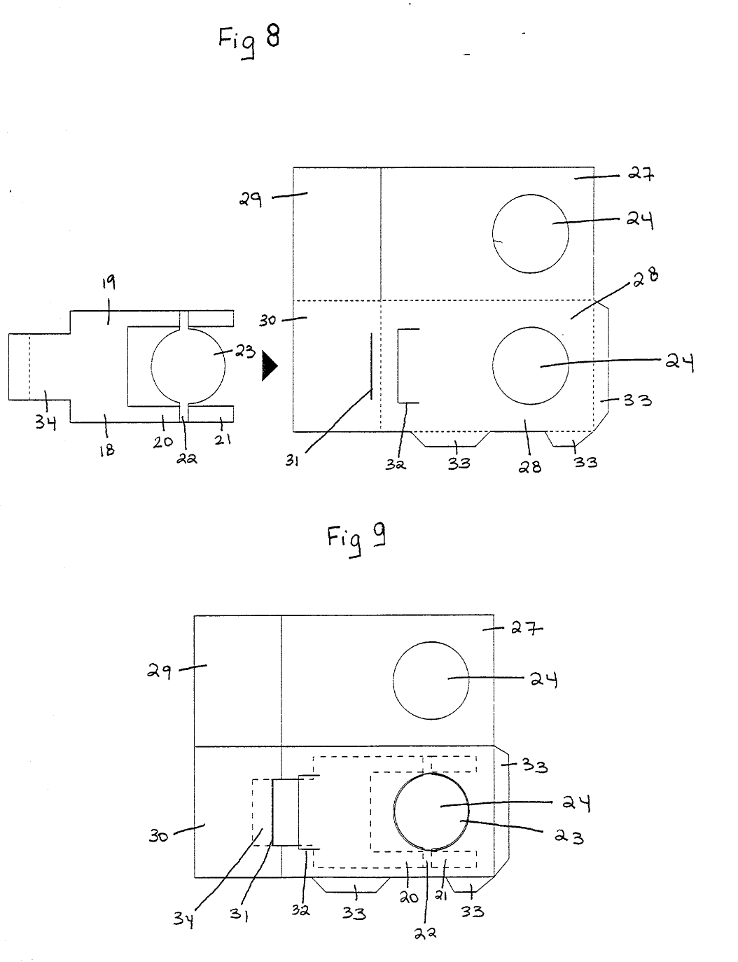

FIGS. 8 through FIGS. 13 represent a second implementation form of the Card with Rotating Pop-up Device. As is illustrated in FIG. 8, this second implementation of the Card with Rotating Pop-up Device also consists of two main elements, the Base 25 the Rotation Device 26. The second implementation differs from the first as follows: (a) the Rotation Device 26 is created from a separate piece of irregularly shaped foldable cardstock, distinct from the Base 25, (b) in addition to a U-Shaped piece 19, 20 and 21 (which in turn is comprised of a rectangular piece 19 and two parallel arms protruding from the rectangular piece 20, each with an arm end 21), a double-sided rotating image carrier 23 and two hinges 22 connecting the arms of the U-shaped piece 19, 20 and 21 to the image carrier 23, the Rotation Device 26 is comprised a slide member 34 protruding from the bottom side of the rectangular piece 19, (c) the panels 27, 28, 29 and 30 that comprise the Base 25 in the second implementation are arranged differently than the panels 14, 15, 16 and 17 that comprise the Base 14, 15, 16 and 17 in the first implementation and (d) the sheet forming the Base 25 contains a number of slits 31 and 32 and flaps 33.

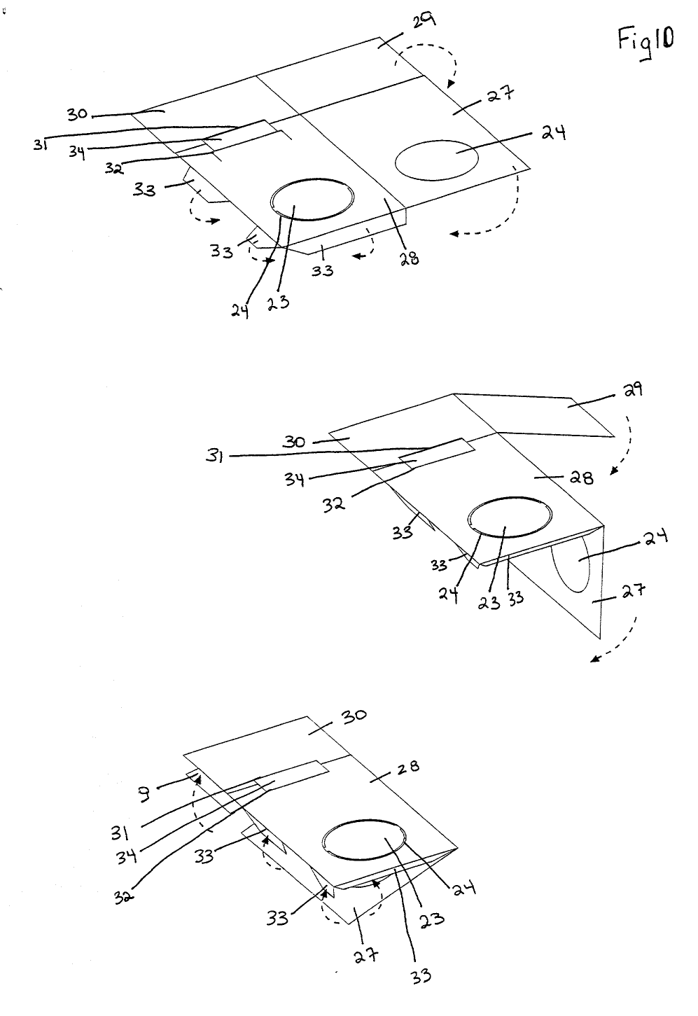

According the FIG. 10, the 1^{st} panel 27 is folded behind the 2^{nd} panel 28 and the 2^{rd} panel 29 is folded behind the 4^{th} panel 30. The flaps 33 on the 2^{nd} panel 28 are then sealed through the use of an adhesive such as glue, to the 1^{st} panel 27, thereby forming a pocket to contain the Rotation Device 26. According to FIG. 9 the Rotation Device 26 must be attached to the backside of the 2^{nd} panel 28 before the 1^{st} panel 27 is sealed to the 2^{nd} panel 28. The slide member 34 of the Rotation Device 26 is extracted from inside the pocket to the inside of the foldable card through the 1^{st} slit 31 and then reinserted into the pocket formed by the 1^{st} panel 27 and 2^{nd} panel 28 through the 2^{nd} slit 32 where it is attached to the 4^{th} panel 30. The arms 20 of the Rotation Device 26 are fastened to the 2^{nd} panel 28, thereby creating the mechanism by which the opening and closing of the card pulls and pushes the slide member 34, thus folding and unfolding the Z-shaped folds on the Rotation Device 26 and rotating the image carrier 23.

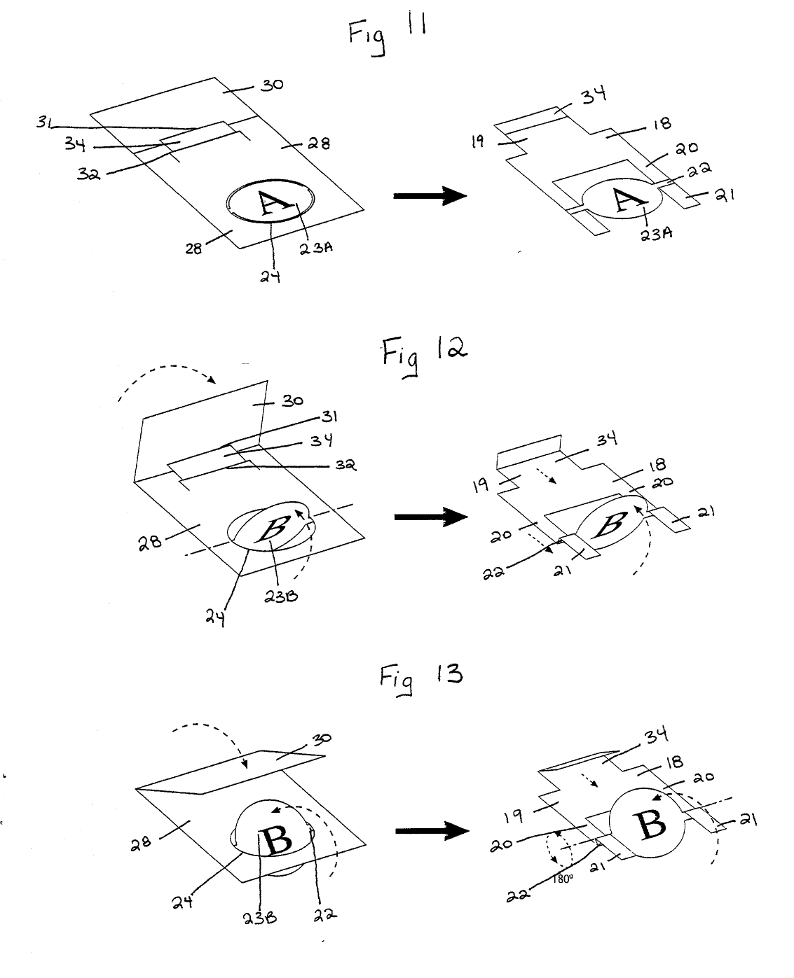

FIG. 11 illustrates the Card with Rotating Pop-up Device when it is in its opened position, with the arms 20 of the Rotation Device 26 flattened and side A of the image carrier 23 displayed. FIG. 12 illustrates the closing of the Card with Rotating Pop-up Device, whereby the slide member 34 is pushed, causing the arms 20 of the Rotation Device 26 to fold into a Z-Shape. This in turn causes the image carrier 23 to begin rotating. FIG. 13 illustrates the Card with Rotating Pop-up Device completely closed, with the arms 20 of the Rotation Device 26 in a complete Z-shaped fold, and the image carrier 23 completely rotated to display side B of the image carrier 23.

The present invention is not intended to be restricted to any particular form or arrangement, or any specific embodiment disclosed herein, or any specific use, since the same may be modified or varied substantially in various particulars or relations without departing from the spirit or scope of the claimed invention hereinabove shown and described, of which the apparatus shown is intended only for illustration and for disclosure of an operative embodiment and not to show all of the various forms or modifications in which the present invention might be embodied or operated.

That which is claimed is:

1. A Pop-up Card comprising a Base of foldable planar material and a Rotation Device, wherein an image carrier rotates through the activation of the Rotation Device.

2. The Pop-up Card of claim 1, wherein the motion of unfolding the Base, thus opening the Card, activates the Rotation Device and causes the image carrier to rotate.

3. The Pop-up Card of claim 2, wherein said image carrier is circular, rectangular, square or irregularly shaped.

4. The Pop-up Card of claim 2 wherein said image carrier displays an image on two sides.

5. The Pop-up Card of claim 2 wherein said image carrier rotates up to 180 degrees, thereby displaying the opposite side of the image carrier.

6. The Pop-up Card of claim 1 wherein said Base is made of a piece of cardstock or other planar material.

7. The Pop-up Card of claim 6 wherein said base is folded along its horizontal and vertical folds, thereby creating a card that can be opened and closed.

8. The Pop-up Card of claim 7 wherein said base contains various perforations, slits, folds and openings of predetermined shapes and sizes, including (but not limited to) sighting windows corresponding to the image carrier.

9. The Pop-up Card of claim 1, wherein said Rotation Device is formed of an irregularly shaped piece of cardstock or other planar material.

10. The Pop-up Card of claim 9 wherein said Rotation Device is comprised of a U-shaped piece (which is in turn comprised of a rectangular piece and two parallel arms protruding from the rectangular piece), a slide member protruding from the bottom side of said U-shaped piece, a rotating image carrier and two “hinges” connecting the arms of the U-shaped piece to the rotating image carrier.

11. The Pop-up Card of claim 10 wherein each arm of said U-shaped piece contains two creases, such that each arm becomes Z-shaped when folded.

12. The Pop-up Card of claim 11 wherein the motion of unfolding the Base, thus opening the card, causes the slide member to be pulled, thereby causing the arms of the Rotation Device to unfold, which in turn causes the image carrier to rotate.

13. The Pop-up Card of claim 11, wherein the motion of folding the Base, thus closing the card, causes the slide member to be retracted thereby causing the arms of the Rotation Device to fold into a Z-shape, which in turn causes the image carrier to rotate.

14. The Pop-up Card of claim 1 wherein said Rotation Device is created inherent in said Base, such that Rotation Device and Base are formed from a single sheet of material.

15. The Pop-up Card of claim 1 wherein said Rotation Device is created separate from said Base, such that Rotation Device and Base are formed from two or more separate sheets of material.

16. The Pop-up Card of claim 15 wherein said Rotation Device and said Base are attached through the use of an adhesive such as glue.

17. The Pop-up Card of claim 15 wherein a slide member of said Rotation Device is inserted through slits of said Base.

18. The Pop-up Card of claim 1, wherein the Base and/or the Rotation Device display text, images or other forms of advertisement.

19. A method of building a pop-up card comprising a base of foldable planar material and a rotation device wherein an image carrier rotates through the activation of the rotation device.
